(19) United States
(12) Patent Application Publication
(10) Pub. No.: US 2026/0057569 A1
(43) Pub. Date: Feb. 26, 2026

(54) METHOD AND DEVICE FOR IMAGE RENDERING, STORAGE MEDIUM AND PROGRAM PRODUCT

(71) Applicant: Beijing Zitiao Network Technology Co., Ltd., Beijing (CN)

(72) Inventors: Fengrui LIU, Beijing (CN); Liliang PAN, Beijing (CN); Wen HAN, Beijing (CN)

(21) Appl. No.: 19/301,659

(22) Filed: Aug. 15, 2025

(30) Foreign Application Priority Data
Aug. 20, 2024 (CN) 202411144812.3

(51) Int. Cl. G06T 11/00; G06F 3/01

(52) U.S. Cl. CPC G06T 11/00; G06F 3/013; G06T 2200/24

(57) ABSTRACT

Embodiments of the present disclosure provide a method and device for image rendering, a storage medium and a product. The method comprises: obtaining a plurality of graphical user interface UI objects to be rendered; for each of the plurality of UI objects, if feature data of the UI object satisfy a first preset condition, rendering and displaying the UI object based on a first processing mode; and if the feature data of the UI object fail to satisfy the first preset condition, rendering and displaying the UI object based on a second processing mode; wherein a resource consumption of the first processing mode is greater than a resource consumption of the second processing mode.

### CROSS-REFERENCE TO RELATED APPLICATION(S)

This application claims priority to Chinese Application No. 202411144812.3 filed Aug. 20, 2024, the disclosure of which is incorporated herein by reference in its entirety.

### FIELD Embodiments of the present disclosure relate to the field of extended reality technology, and more specifically, to method and device for image rendering, storage medium and program product.

### BACKGROUND

In Extended Reality (XR) headset devices, such as Virtual Reality (VR) all-in-one, graphical user interface (UI) objects are displayed in high definition, to facilitate the users to interact with the VR system.

In the related art, the Compositor Layers technique is usually adopted to render and display the UI objects in each frame of image in a definition greater than the definition utilized in the routine rendering on the screen.

However, inventors have discovered that the prior art at least has the following technical problems: in case of a large number of UI objects, the resource consumption soars. For example, the rendering pressure on the GPU is significantly increased, the risk of screen tearing grows and too much electric energy is consumed.

### SUMMARY

Embodiments of the present disclosure provide a method and device for image rendering, a storage medium and a program product to lower the resource consumption.

In accordance with a first aspect, embodiments of the present disclosure provide a method for image rendering, including:
obtaining a plurality of graphical user interface UI objects to be rendered;
for each of the plurality of UI objects, if feature data of the UI object satisfy a first preset condition, rendering and displaying the UI object based on a first processing mode; and if the feature data of the UI object fail to satisfy the first preset condition, rendering and displaying the UI object based on a second processing mode; wherein a resource consumption of the first processing mode is greater than a resource consumption of the second processing mode.

In accordance with a second aspect, embodiments of the present disclosure provide a device for image rendering, including:
an obtaining module configured to obtain a plurality of graphical user interface UI objects to be rendered;
a rendering module configured to, for each of the plurality of UI objects, if feature data of the UI object satisfy a first preset condition, render and display the UI object based on a first processing mode; and if the feature data of the UI object fail to satisfy the first preset condition, rendering and displaying the UI object based on a second processing mode; wherein a resource consumption of the first processing mode is greater than a resource consumption of the second processing mode.

In accordance with a third aspect, embodiments of the present disclosure provide an electronic device, including: a processor and a memory;
wherein the memory is stored with computer-executable instructions;
the processor executes computer-executable instructions stored in the memory, such that the at least one processor performs the method for image rendering according to the first aspect and various possible designs of the first aspect.

In accordance with a fourth aspect, embodiments of the present disclosure provide a computer-readable storage medium stored with computer-executable instructions, wherein the computer-executable instructions, when executed by a processor, implement the method for image rendering according to the first aspect and various possible designs of the first aspect.

In accordance with a fifth aspect, embodiments of the present disclosure provide a computer program product, including a computer program, wherein the computer program, when executed by a processor, implements the method for image rendering according to the first aspect and various possible designs of the first aspect.

Embodiments provide a method and device for image rendering, a storage medium and a program product. The method includes first obtaining a plurality of graphical user interface UI objects to be rendered; for each of the plurality of UI objects, if feature data of the UI object satisfy a first preset condition, rendering and displaying the UI object based on a first processing mode; and if the feature data of the UI object fail to satisfy the first preset condition, rendering and displaying the UI object based on a second processing mode; wherein a resource consumption of the first processing mode is greater than a resource consumption of the second processing mode. The method provided by embodiments of the present disclosure dynamically selects the UI objects based on the preset condition, so as to process only part of the UI objects satisfying the screening condition in the first processing mode with high resource consumption, e.g., display in high definition. Therefore, the resource consumption is lowered, e.g., the resources consumed by the graphics card are lowered, the rendering pressure on GPU is decreased and the risk of screen tearing is reduced. Meanwhile, the battery consumption is also lowered and the battery life of the all-in-one machine is enhanced.

### BRIEF DESCRIPTION OF THE DRAWINGS

Brief introduction of the drawings required in the following description of the embodiments or the prior art are to be introduced simply below to more clearly explain the technical solutions according to the embodiments of the present disclosure or in the related art. It is obvious that the following drawings only illustrate some embodiments of the present disclosure and those skilled in the art also may obtain other drawings on the basis those illustrated ones without any exercises of inventive work.

FIG. 1 a schematic diagram of an application scenario of the method for image rendering;

FIG. 2 illustrates a schematic flowchart I of the method for image rendering provided by an embodiment of the present disclosure;

FIG. 3 illustrates a schematic diagram of the principles for determining the UI object in the field of view provided by an embodiment of the present disclosure;

FIG. 4 illustrates a schematic flowchart II of the method for image rendering provided by an embodiment of the present disclosure;

FIG. 5 illustrates a schematic flowchart III of the method for image rendering provided by an embodiment of the present disclosure;

FIG. 6 illustrates a schematic flowchart IV of the method for image rendering provided by an embodiment of the present disclosure;

FIG. 7 illustrates a schematic flowchart V of the method for image rendering provided by an embodiment of the present disclosure;

FIG. 8 illustrates a structural diagram of the device for image rendering provided by an embodiment of the present disclosure;

FIG. 9 illustrates a structural diagram of an electronic device provided by embodiments of the present disclosure.

### DETAILED DESCRIPTION OF EMBODIMENTS

For a clearer picture of the objectives, technical solutions and advantages of the embodiments of the present disclosure, the technical solutions in the embodiments of the present disclosure are to be described clearly and completely with reference to the drawings in the embodiments of the present disclosure. It is obvious that the described embodiments are only part of the embodiments of the present disclosure, rather than all of them. All other embodiments obtained by those skilled in the art on the basis of the illustrated embodiments of the present disclosure without any exercises of inventive work fall within the protection scope of the present disclosure.

UI, as a medium for interactions and information exchange between a system and a user, converts internal forms of the information into forms acceptable to people. With the UI, the users can easily and effectively operate the hardware to perform two-way interactions and complete the desired work. The user interface, as broadly defined, includes human-computer interaction interfaces and graphical user interfaces. The user interface is present in any fields involving information exchange between humans and machines. If the UI object is displayed in a higher definition in the XR headset device, the usage experience of the user can be enhanced and it is convenient for the user to interact with the system of the headset device.

In the related art, during the VR rendering, scene contents may be rendered by left-eye and right-eye cameras and drawn to left Eye Buffer and right Eye Buffer; after the drawing is completed, the Eye Buffers are also distorted and sampled by the ATW thread before being finally rendered onto the VR screen. In this way, the size of the canvas of the Eye Buffer is usually smaller than a screen size; accordingly, when the UI object is drawn on the canvas and then rendered to the screen, it is required to perform texture sampling, to stretch the image to adapt to the screen size. As a result, the display definition of the UI object will be lowered. To increase the definition, the VR Compositor Layers technique may be adopted to render and display the UI objects on the screen in high definition. Specifically, based on this technique, instead of directly rendering the scene contents to the Eye Buffer, the scene contents are distorted, sampled and synthesized by the ATW thread via “passthrough”. The benefit of such approach is to avoid an additional texture sampling and enhance the definition of the texture and the video.

However, in the process of rendering and displaying all UI objects in high definition, the rendering pressure on the Graphics Processing Unit (GPU) is significantly increased. Under the constant screen refresh rate, the rendering speed of the GPU could not synchronize with line-by-line refresh rate of screen pixels, which may increase the risk of screen tearing. Meanwhile, in the case that the headset device is an all-in-one machine, the battery capacity is restricted, which would also influence the battery life of the all-in-one machine.

To address the above technical problems, the inventor has discovered through research that if only part of the UI objects is displayed in high definition, the consumption of graphics resources is lowered and the rendering pressure on the GPU is reduced. Specifically, a determination strategy is designed to select the UI objects that the user might have more interests in and display them in a high definition, while the rest UI objects are displayed in a low definition. On this basis, embodiments of the present disclosure provide a method for image rendering.

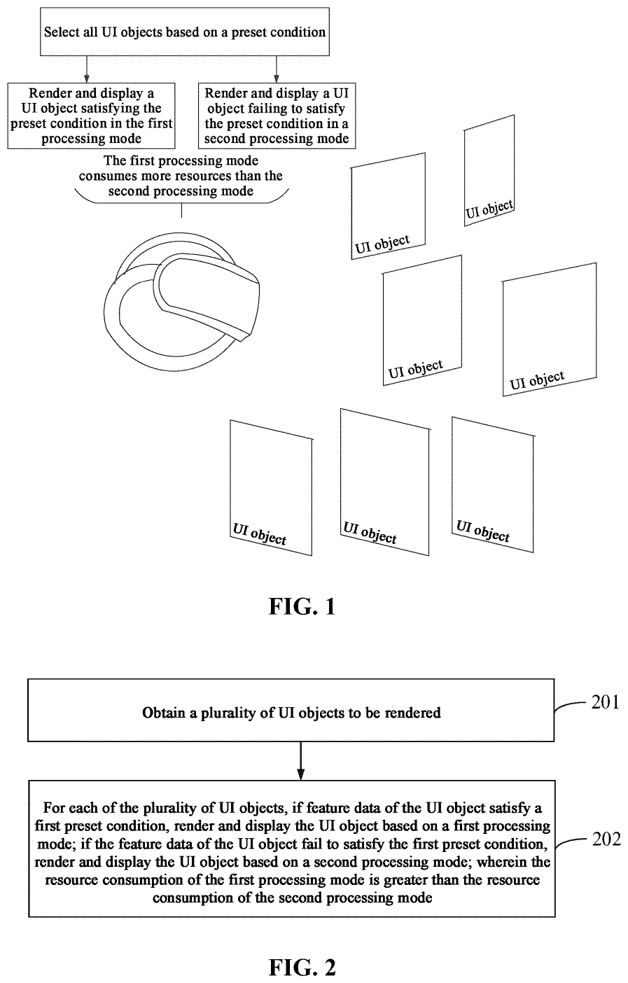

FIG. 1 illustrates a schematic diagram of an application scenario of the method for image rendering. FIG. 1 shows a headset device, e.g., VR all-in-one. In a current image frame displayed on a screen, a plurality of UI objects is present and all of the UI objects are displayed in high definition, which would increase the rendering pressure on the GPU and raise the risk of screen tearing. Accordingly, before the image frame is rendered and displayed, a plurality of graphical user interface UI objects to be rendered is obtained; for each of the plurality of UI objects, if feature data of the UI object satisfy a first preset condition, the UI object is rendered and displayed based on a first processing mode to display; and if the feature data of the UI object fail to satisfy the first preset condition, the UI object is displayed and rendered based on a second processing mode; wherein a resource consumption of the first processing mode is greater than a resource consumption of the second processing mode. The method for image rendering provided by embodiments of the present disclosure dynamically selects the UI objects based on the preset condition, so as to process only part of the UI objects satisfying the screening condition in the first processing mode with high resource consumption, e.g., display in high definition. Therefore, the resource consumption is lowered, e.g., the resources consumed by the graphics card are lowered, the rendering pressure on GPU is decreased and the risk of screen tearing is reduced. Meanwhile, the battery consumption is also lowered and the battery life of the all-in-one machine is enhanced.

It is to be explained that the schematic diagram of the scenario illustrated in FIG. 1 is just an example. The method for image rendering and the scenario are described in the embodiments of the present disclosure to more clearly explain the technical solution of the embodiments of the present disclosure, rather than restricting the technical solution provided by the embodiments of the present disclosure. Those skilled in the art understand that the technical solution according to the embodiments of the present disclosure also apply to similar technical problems as the system evolves and the new scenarios emerge.

The technical solution of the present disclosure is to be described in details below with reference to specific embodiments. The following specific embodiments may be combined with each other. Same or similar concepts or procedures will not be repeated in certain embodiments.

FIG. 2 illustrates a schematic flowchart I of the method for image rendering provided by an embodiment of the present disclosure. The method for image rendering includes:

201: obtaining a plurality of UI objects to be rendered.

The executive body of this embodiment of the present disclosure is XR device, e.g., the VR all-in-one shown in FIG. 1.

Specifically, the virtual reality technique integrates computer, electronic information and simulation, and the basic implementation is to cause the computer to simulate a virtual environment to bring an immersive experience to people within the environment. The user wears the headset device, e.g., the VR all-in-one, and feels immersed in the environment through a 3D scene displayed on the screen, i.e., VR space. The 3D scene is displayed through rendering the image frame at a given screen refresh rate. The image frame may include a plurality of UI objects (e.g., interface for video play, interface for receiving and sending emails, gaming interface, chat interface and setting interface etc.) simultaneously. The plurality of UI objects may be from the image frame to be rendered, and the image frame to be rendered indicates an image frame displayed on the screen to be rendered based on the screen refresh rate.

202: for each of the plurality of UI objects, if feature data of the UI object satisfy a first preset condition, rendering and displaying the UI object based on a first processing mode; and if the feature data of the UI object fail to satisfy the first preset condition, rendering and displaying the UI object based on a second processing mode; wherein a resource consumption of the first processing mode is greater than a resource consumption of the second processing mode.

Specifically, the plurality of UI objects is dynamically screened based on the first preset condition, to select a part of the UI objects, which is to be processed in the first processing mode with high resource consumption, while the other part of UI objects is processed in the second processing mode with low resource consumption, thereby balancing between overall resource consumption and visual experience.

Wherein the resource consumption may be CPU and GPU etc., and also may be electric energy resource.

In one embodiment of the present disclosure, the rendering and displaying the UI object based on a first processing mode may include: refreshing a window of the UI object at a first refresh rate; the rendering and displaying the UI object based on a second processing mode may include: refreshing a window of the UI object at a second refresh rate; wherein the first refresh rate is greater than the second refresh rate.

In one embodiment of the present disclosure, the rendering and displaying the UI object based on a first processing mode may include: rendering a window of the UI objects with a first resolution; the rendering and displaying the UI object based on a second processing mode may include: rendering a window of the UI objects with a second resolution; wherein the first resolution is greater than the second resolution.

In one embodiment of the present disclosure, the rendering and displaying the UI object based on a second processing mode includes at least one of: freezing a process corresponding to the UI object and displaying, in a window of the UI object, a first image which is rendered and displayed before freezing of process; ending a process corresponding to the UI object and displaying, in a window of the UI object, a second image which is rendered and displayed before freezing of process. The rendering and displaying the UI object based on a first processing mode may include: continuing to render and display the UI object based on current rendering display parameters. For example, when the second processing mode is to freeze the process corresponding to the UI object, the first processing mode may continue to maintain the process without processing it. When the second processing mode is to end the process corresponding to the UI object, the first processing mode may continue to maintain the process, rather than ending it.

In one embodiment of the present disclosure, the rendering and displaying the UI object based on a first processing mode includes at least one of: refreshing a window of the UI object at a first refresh rate; rendering a window of the UI objects with a first resolution; the rendering and displaying the UI object based on a second processing mode includes at least one of: processing 1: refreshing a window of the UI object at a second refresh rate; wherein the first refresh rate is greater than the second refresh rate; processing 2: rendering a window of the UI objects with a second resolution; wherein the first resolution is greater than the second resolution; processing 3: freezing a process corresponding to the UI object and displaying, in a window of the UI object, a first image which is rendered and displayed before freezing of process; processing 4: ending a process corresponding to the UI object and displaying, in a window of the UI object, a second image which is rendered and displayed before freezing of process.

Wherein, in the processing 1, the preset frequency may be smaller than or equal to 50 Hz, e.g., 45 Hz. In the processing 2, the preset ratio may be lower than or equal to 95%, such as 90%. In the processing 3, when the process is frozen, it means that the process stops using CPU and memory resources but still remains in the memory (which may be understood as “semi-active” state); in such case, it is impossible for the corresponding application to respond to user interactions; if the user switches the operation focus to this application, the process is immediately restored from the frozen state to the normal “active” state. In the frozen state, the resource allocation of the application stops using CPU and memory resources, but the process is still remained in the memory and may be quickly woken up for use. In the interface of the application in the frozen state, the page may be displayed as the last frame snapshot before freezing and the window is not closed; any logic requiring real-time call of system interface, such as video play, audio play and location refresh etc., are no longer performed; no interactions are implemented; when the user switches the focus back, it is only required to wake up the interface before freezing after the allocation of the memory resources, without restarting the process. In the processing 4, the process is ended; specifically, the page is displayed as the last frame snapshot before freezing and the window is not closed; when the user switches the focus back, the process is restarted.

Specifically, the processing 1-4 may be combined freely. To provide the user with a high-level experience as long as possible, the method for image rendering provided by the embodiment of the present disclosure may be implemented only when the resource consumption is at a certain level, i.e., the dynamic screen is performed based on the first preset condition, to render and display different UI objects in various processing modes with distinct consumptions. Accordingly, the overall resource consumption is lowered to extend the service life of the headset device.

As an example, priority of a plurality of UI objects may be graded based on the feature data of the UI objects (in the grading, a corresponding score may be given in accordance with which conditions are satisfied by the feature data of the UI object, and a total score is obtained accordingly; for example, if the UI object is within a field of view, it may obtain 20 points; if the UI object is the focus UI, it may obtain 50 points and so on), such that in the case that the resource consumption has reached a preset value (e.g., power consumption of a certain performance module reaching a preset indicator), if the score of the UI object satisfies a preset condition (such as the UI having the lowest score in the plurality of UI objects), the UI object may be subject to processing 1 (e.g., decreasing the window refresh rate to 45 Hz) or processing 2 (reducing the window render resolution to 90% of the original resolution).

In one implementation, optimization measure is executed following a circular logic. That is, it is immediately observed after the execution whether the resource consumption is below a preset value, i.e., whether below an optimization line; if no, the optimization continues. Therefore, the optimization measure is executed in the following order: when it is first monitored that an indicator is above the line, the window refresh rate corresponding to the process having the lowest priority grade is decreased to 45 Hz and marked. Then, the indicator is observed again; if it is still above the line, the window render resolution corresponding to the process marked with reduced frame is lowered by 10% and marked. The indicator is further observed; if it is still above the line, the window refresh rate corresponding to the process having the lowest priority grade (excluding the process already marked with reduced frame and lowered resolution) is decreased to 45 Hz and marked. The cycle continues until the indicator is below the optimization line.

In one embodiment of the present disclosure, the rendering and displaying the UI object based on a first processing mode may include: rendering and displaying the UI object in a first definition; the rendering and displaying the UI object based on a second processing mode may include: rendering and displaying the UI object in a second definition, wherein the first definition is greater than the second definition. Specifically, for each of the plurality of UI objects, if feature data of the UI object satisfy a first preset condition, the UI object is rendered and displayed in a first definition; and if the feature data of the UI object fail to satisfy the first preset condition, the UI object is rendered and displayed in a second definition; wherein the first definition is greater than the second definition.

To render the image frame to be rendered, the resources of the graphics card are consumed, which may increase the pressure on GPU. Once the GPU pressure has increased to a certain level, the rendering speed of the graphics card could not keep up with line-by-line refresh rate of screen pixels, resulting into screen tearing. To lower the risk of screen tearing, the priority of the plurality of UI objects may be classified; it is determined that the UI objects satisfying the preset condition have a high priority; accordingly, the UI objects may be processed based on the Compositor Layers technique (which consumes a lot of resources of the graphics card), to obtain a high definition. However, the UIs object failing to meet the preset condition may be conventionally rendered (the UI object is rendered by the left-eye and right-eye cameras and drawn to the Eye Buffer; after the drawing is completed, Eye Buffer is also distorted and sampled by the ATW thread, such that the UI object is finally rendered on the VR screen), to reduce the consumption on the graphics resources. Therefore, the UI objects are displayed in the screen in a low definition. Alternatively, after it is determined that the UI objects failing to meet the preset condition have a low priority, these UI objects are continued to be classified, i.e., the second definition may include a plurality of definitions, but all of them must be lower than the first definition. The UI objects having a low priority are further classified, so as to be displayed differently in a plurality of definitions included in the second definition. This embodiment is not restricted in this regard.

In one embodiment of the present disclosure, the rendering and displaying the UI object based on a first processing mode may include: based on the VR Compositor Layers technique, submitting a scene content corresponding to the UI object directly to an asynchronous timewarp ATW thread for processing without being rendered by a rendering thread, to further render and display in a first definition on a screen of a headset device; the rendering and displaying the UI object based on a second processing mode may include: submitting a scene content corresponding to the UI object to a rendering thread for rendering of left-eye and right-eye cameras and submitting data rendered in left-eye and right-eye rendering buffers to an asynchronous timewarp ATW thread for processing, to render and display in a second definition on a screen of a headset device.

Specifically, in the headset device, e.g., VR all-in-one, the definition of the UI object may be enhanced through the Compositor Layers technique; however, if there are too many passthrough contents, the rendering pressure on GPU increases significantly and the risk of screen tearing also grows. Embodiments of the present disclosure screen part of the UI objects through the dynamic passthrough strategy to render and display in a high definition, thereby balancing the definition and the performance. A determination is comprehensively made with reference to visibility of the UI object, the latest interaction interval and the like, to ensure that the UI objects of high priority are passed through, and the rest UIs with low priority are in non-passthrough mode. This enhances the overall performance and the battery life of the all-in-one machine while it is guaranteed that the interactive objects of the user of the all-in-one machine have the optimal definition. Meanwhile, the all-in-one machine can open more UI objects through the performance balance strategy.

The high definition (first definition) is achieved by the Compositor Layer technique, and the low definition (second definition) is implemented through conventional Eye Buffer rendering procedures. Specifically, in the routine rendering procedure of the VR, the scene contents are rendered by the left-eye and right-eye cameras and drawn on the Eye Buffer; after the drawing is completed, the Eye Buffer is also distorted and sampled by the ATW thread, so as to finally render the scene contents onto the VR screen. The VR Compositor Layer technique proposes a rendering method different from the one for “directly rendering the scene contents to the Eye Buffer”. In other words, in this technique, instead of directly rendering the scene contents to the Eye Buffer, the scene contents are distorted, sampled and synthesized by the ATW thread via “passthrough”. The benefit of such approach is to avoid an additional texture sampling and enhance the definition of the texture and the video.

In one embodiment of the present disclosure, the feature data of the UI object may include at least one of: a type, a position, an area of a non-occluded part, or interactive data.

Wherein the type of the UI object may be determined based on the source and the purpose of the UI object. When the UI object is displayed in the VR space, it may be occluded by the adjacent UI objects; accordingly, the area of the non-occluded part of the UI object refers to the area of an exposed part. The interactive data of the UI object indicate data related to the use of the UI by the user. For example, the user injects (e.g., confirm, return or drag) an interaction time to an interaction point through a handle button; after the injection is completed, the interacted UI object is recorded as the focus UI and the recording time is the focus time; when gestures are used, the position and the orientation of the user's hands are obtained in real time to calculate the interaction point, and the events, such as confirm, return and drag etc., are triggered by a fixed gesture; when the trigger is ended, the interacted UI object is recorded as the focus UI and the recording time is the focus time.

In one embodiment of the present disclosure, the feature data of the UI object satisfying a first condition includes: feature data of the UI object belonging to a preset type.

Wherein the preset type may be safety type. During the use of the VR all-in-one, there is a risk that the machine would collide with the surrounding environment. A safety area may be configured to avoid collisions. When users exit the safety area, a prompt may be issued. The UI objects related to the safety function may be classified as safety type. To guarantee the safety of the users, the UI objects of the safety type may all be processed in the first processing mode, e.g., displayed in the first definition (i.e., the high definition).

In one embodiment of the present disclosure, the preset type may include a customized type; the method also may include: in response to an operation of triggering a first control in the setting interface, the type of the selected UI object is determined as the customized type.

Specifically, the users usually have their own habits when using the headset device, e.g., VR all-in-one. To facilitate the users to make individualized settings and enhance the user experience, the users are provided with a setting for UI objects of customized type. For example, if the users are more interested in chat experience, they may set the chat UI as the customized type, to render and display the chat UI in high definition.

In one embodiment of the present disclosure, in the case that a type of the UI object does not belong to a preset type, the feature data of the UI object satisfying a first condition includes satisfying at least one of: condition 1: a position of the UI object being located within a field of view; condition 2: a ratio of an area of non-occluded part of the UI object to a total area of the UI objects being greater than a first preset ratio; condition 3: a ranking of a ratio of an area of non-occluded part of the UI object to a total area of the UI object being lower than a first preset ranking in a ratio order; wherein the ratio order is obtained by sorting ratios of areas of non-occluded parts respectively corresponding to the plurality of UI objects to a corresponding total area in a descending order; condition 4: a ranking of a focus time corresponding to the UI object being lower than a second preset ranking in a focus order; wherein the focus order is obtained by sorting focus times respectively corresponding to the plurality of UI objects in a chronological order; the focus time corresponds to a time when a UI object is recorded as a focus UI after completing an interactive event injection.

Specifically, in the case that the preset type is considered as the condition of a high priority, the UI objects failing to satisfy the preset type may be further determined based on the conditions 1-4. One or more conditions may be selected from the conditions 1-4 and further combined to obtain the first preset condition. As an example, the condition 1 may serve as the first preset condition; the conditions 1 and 2 may collectively serve as the first preset condition; the conditions 1-3 may collectively serve as the first preset condition; the conditions 1-4 may collectively serve as the first preset condition; the conditions 1, 2 and 4 may collectively serve as the first preset condition; the conditions 1, 3 and 4 may collectively serve as the first preset condition; the conditions 2 and 4 may collectively serve as the first preset condition.

For condition 1, the UI management system of the all-in-one machine can detect the visible state of each UI object in real time. For the UI objects which are completely or partly within the field of view of the users, the high-definition passthrough is preferred since these UI objects have the greatest impact on the user experience. The passthrough priority of the UIs which are occluded by other UI objects or located at the edge of the screen may be lowered to reduce the rendering load on the GPU.

For condition 4, by recording the recent interaction time between the user and each UI object, it is determined which UIs are of the most relevance or importance for the user at the present. The recently interacted UIs should be given a higher passthrough priority because they might become the focus of the user again. For those UIs which have not been interacted for a long time, the definition may be temporarily decreased to save the GPU resources.

Wherein, in one embodiment of the present disclosure, the method further includes: obtaining a current pose of a headset device; determining a field of view of a headset device according to the current pose.

In one implementation, the current pose of the headset device may be obtained; a view frustum pose of the headset device is determined according to the current pose; a position of the UI object being located in a field of view may include: a position of the UI object being within the view frustum.

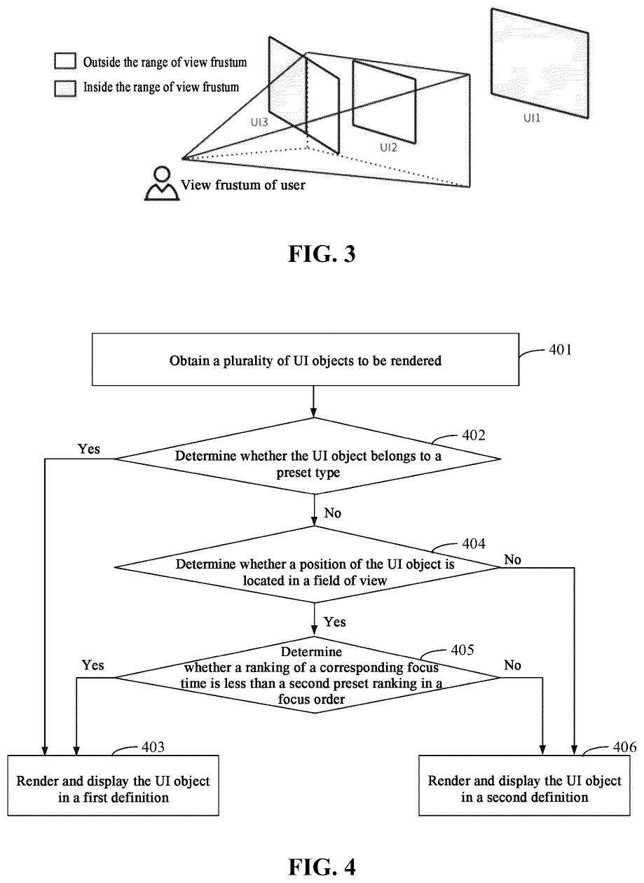

As an example, the corresponding view frustum pose may be determined according to the current pose of the headset device, to further determine whether each UI object is within the view frustum. If yes, it is indicated that the UI object is located in the field of view. As shown in FIG. 3, the UI1 is outside the view frustum, i.e., the UI1 is outside the field of view; the UI2 is completely within the view frustum, so it is determined that the UI2 is in the field of view; the UI3 is partly within the view frustum, so it is determined that the UI3 is in the field of view.

In another implementation, the current pose of the headset device may be obtained; a current eye movement tracking result is obtained; a field of view of a headset device is determined based on the current pose and the eye movement tracking result. Specifically, the field of view determined based on the eye movement tracking function of the headset device is relatively broad. To further save the power consumption and lower the resource consumption, the field of view may be further confirmed with reference to the current pose of the headset device.

In one embodiment of the present disclosure, the feature data of the UI object satisfying a first condition includes satisfying at least one of: condition 1: a position of the UI object being located within a field of view; condition 2: a ratio of an area of non-occluded part of the UI object to a total area of the UI objects being greater than a first preset ratio; condition 3: a ranking of a ratio of an area of non-occluded part of the UI object to a total area of the UI object being lower than a first preset ranking in a ratio order; wherein the ratio order is obtained by sorting ratios of areas of non-occluded parts respectively corresponding to the plurality of UI objects to a corresponding total area in a descending order; condition 4: a ranking of a focus time corresponding to the UI object being lower than a second preset ranking in a focus order; wherein the focus order is obtained by sorting focus times respectively corresponding to the plurality of UI objects in a chronological order; the focus time corresponds to a time when a UI object is recorded as a focus UI after completing an interactive event injection; condition 5: the UI object belonging to a preset type.

Specifically, conditions 1-5 may be freely combined to obtain the first preset condition. With an increasing number of conditions are involved, the first preset condition becomes harsher, fewer UI objects satisfy the first preset condition and fewer UI objects are displayed in a high definition. As a result, fewer graphics resources are consumed and the pressure added on the GPU also decreases. Of process, the visual experience of the user also degrades. Thus, the preset condition may be set depending on the actual requirements. This embodiment is not restricted in this regard.

It is known from the above description that the UI objects are dynamically screened based on the preset conditions, so as to process only the UI objects satisfying the screen condition in the first processing mode with high energy consumption, e.g., the UI objects are displayed in high definition. Therefore, the resource consumption is lowered, e.g., the resources consumed by the graphics card are lowered, the rendering pressure on GPU is decreased and the risk of screen tearing is reduced. Meanwhile, the battery consumption is also lowered and the battery life of the all-in-one machine is enhanced.

In one embodiment of the present disclosure, based on the above embodiments, e.g., the embodiment shown in FIG. 2, before the step 201, the method also may include: in response to an operation of triggering a second control in the setting interface, determining a target visual experience level; different visual experience levels correspond to various strict degrees of the preset conditions for rendering and displaying the UI object; determining a preset condition corresponding to the target level as the first preset condition.

In view of the preferences of different users, the users may be allowed to adjust the passthrough strategy by preferences. For example, some users would value the performance more and be willing to sacrifice the definition; while some other users may be more interested in visual experience and willing to accept higher GPU pressure. The all-in-one machine can better satisfy the needs of different users by providing a customization option. On this basis, the user also may be provided with different levels for selection and different levels correspond to various strict degrees of the preset condition.

As an example, the visual experience may be divided into three levels. The first-level visual experience is the highest, and the preset condition corresponding to the first level may be set as satisfying the condition 1 (the position of the UI object being located within a field of view); the second-level visual experience is the second highest, and the preset condition corresponding to the second level may be set as satisfying the condition 1 and the condition 4 (a ranking of a focus time corresponding to the UI object being lower than a second preset ranking in a focus order; wherein the focus order is obtained by sorting focus times respectively corresponding to the plurality of UI objects in a chronological order; the focus time corresponds to a time when a UI object is recorded as a focus UI after completing an interactive event injection). The third-level visual experience is the lowest and its corresponding preset condition may be set as satisfying the condition 1, the condition 3 (a ranking of a ratio of an area of non-occluded part of the UI object to a total area of the UI object being lower than a first preset ranking in a ratio order; wherein the ratio order is obtained by sorting ratios of areas of non-occluded parts respectively corresponding to the plurality of UI objects to a corresponding total area in a descending order) and the condition 4.

In one embodiment of the present disclosure, the screen strategy may be dynamically adjusted according to the current system state (e.g., load and battery capacity of the CPU and the GPU). In case of a shortage of system resources, the passthrough level of the non-key UIs may be further decreased, to ensure that the core application and the recently interacted UIs can have sufficient resources. In case of sufficient system resources, the restriction may be relaxed to allow passthrough of more UIs in high definition. By reducing unnecessary GPU rendering jobs, the dynamic definition strategy can lower the overall energy consumption and indirectly improve the battery life of the all-in-one machine. Especially in the battery-powered situations, such strategy can remarkably extend the service time without compromising the user experience.

FIG. 4 illustrates a schematic flowchart II of the method for image rendering provided by an embodiment of the present disclosure. According to the exemplary description in this embodiment, the priority of the UI objects is determined based on the UI type, whether the UI being in the field of view and the ranking of the UI in the focus order among other conditions. The first processing mode is to render and display the UI in the first definition and the second processing mode is to render and display the UI in the second definition. The method for image rendering includes:
401: obtaining a plurality of UI objects to be rendered.
402: for each of the plurality of UI objects, determining whether the UI object belongs to a preset type; if yes, executing step 403; if not, executing step 404.
403: rendering and displaying the UI object in a first definition.
404: determining whether a position of the UI object is located in a field of view; if yes, executing step 405; if not, executing step 406.
405: determining whether a ranking of a focus time corresponding to the UI object being lower than a second preset ranking in a focus order; wherein the focus order is obtained by sorting focus times respectively corresponding to the plurality of UI objects in a chronological order; the focus time corresponds to a time when a UI object is recorded as a focus UI after completing an interactive event injection; if yes, executing step 403; if not, executing step 406.
406: rendering and displaying the UI object in a second definition, wherein the first definition is greater than the second definition.

Specifically, for a plurality of UI objects in the image frame to be rendered, the dynamic selection may be performed based on the type, the visibility and the latest interaction intervals of the respective UI objects, to select the UI objects having a high priority, which are rendered and displayed in a high definition (first definition). The rest UI objects having a low priority are rendered and displayed in a second definition lower than the first definition.

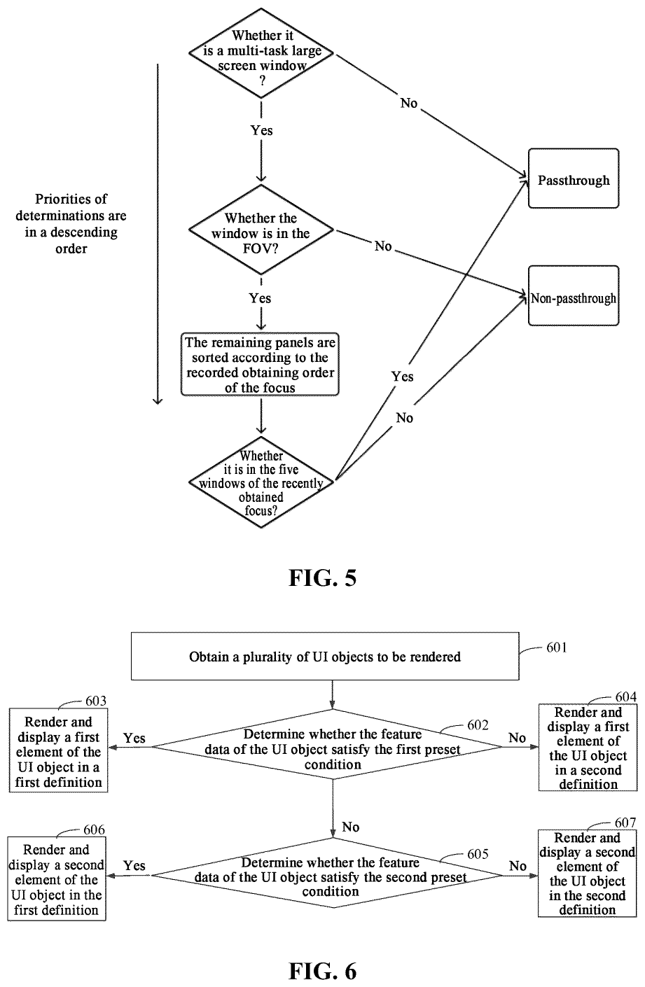

As an example, it is assumed that the preset type is a non-third party nonresident type, i.e., the UI of the application built in the all-in-one machine. As shown in FIG. 5, it is first determined whether the UI type is a third-party nonresident (multi-task large screen window in FIG. 5); the non-third party nonresident application UI is determined as a frequently used UI and the passthrough is regularly used to ensure high definition. Then, according to the position and the orientation of the view frustum of the all-in-one machine, i.e., the position of the UI object, i.e., size, it is determined whether the UI in the VR space is in the FOV (field of view of the all-in-one machine); the UI object is considered in the FOV as long as any point of the UI object is in the view frustum. For the UI objects outside the field of view of the users, the non-passthrough is regularly used to reduce performance overheads and enhance the battery life of the all-in-one machine. For the UI objects in the FOV, the ratio of their exposed parts (which appear in the FOV and are not occluded by other contents) may be further calculated. If the unoccluded ratio is greater than a threshold or the unoccluded ratio is ranked in the first n, the passthrough is performed; otherwise, the passthrough is not executed. In the end, the user of the all-in-one machine may interact with the UI through handle devices or gestures. When the user is using the handle device, the all-in-one machine will track the position and the orientation of the handle in real time and display a ray according to the orientation and the position of the handle; the point where the ray impacts on the UI plane is the interaction point; the user injects (e.g., confirm, return and drag) the interactive event at the interaction point through the handle button. When the user is using gestures, the position and the orientation of the hands of the user are obtained in real time to calculate the interaction point and the events, such as confirm, return and drag etc., are triggered by a fixed gesture. Every time the all-in-one machine interacts with a certain UI to inject events like confirm, return and drag etc., the UI is recorded as the focus UI, i.e., the focus is obtained. The panels, which are filtered by the above conditions, are sorted according to the obtaining order of the focus. The more recent the focus time is, the higher the UI is ranked. The UIs in the first n (e.g., n being 5) are passed through, to ensure that the UI objects frequently used by the user in recent time have a high definition, and the other UIs are in the non-passthrough mode, to lower the performance overheads and enhance the battery life of the all-in-one machine.

As known from the above description, the UI object at the center of the field of view is in high definition and the UI object at the edge of or outside of the field of view is in low definition during the use of the all-in-one machine. A preset number (e.g., 5) of UIs recently interacted with the user are in high definition while the rest is in low definition. While the user is interacting with different panels and moving freely with the all-in-one machine on, the definition of the UI objects would dynamically change with the above conditions.

In one embodiment of the present disclosure, the UI object includes a plurality of elements; the plurality of elements correspond respectively to their own preset conditions; the rendering and displaying the UI object based on a first processing mode if feature data of the UI object satisfy a first preset condition; and rendering and displaying the UI object based on a second processing mode if the feature data of the UI object fail to satisfy the first preset condition, the first processing mode consuming more resources than the second processing mode may include: for each element of the UI object, if feature data of the UI object satisfy a preset condition corresponding to the element, rendering and displaying the element in a first processing mode; if feature data of the UI object fail to satisfy a preset condition corresponding to the element, rendering and displaying the element in a second processing mode, wherein the first processing mode consumes more resources than the second processing mode.

As an example, assuming that the UI object includes element 1, element 2 and element 3, the elements 1-3 each have their own corresponding preset conditions. For example, the element 1 corresponds to condition A; the element 2 corresponds to condition B; and the element 3 corresponds to condition C. On this basis, some elements may be processed in the first processing mode as they satisfy the corresponding preset conditions, and the other elements may be processed in the second processing mode as they fail to meet the corresponding preset conditions. For example, when the feature data of the UI object satisfy the conditions A and B, but fail to meet the condition C, both element 1 and element 2 are processed in the first processing mode with high resource consumption, and element 3 is processed in the second processing mode with low resource consumption. The overall resource consumption is further reduced.

It is to be explained that the first processing mode and the second processing mode may include various modes. Every mode belonging to the first processing mode consumes more resources than every mode belonging to the second processing mode. Based on the above example, the first processing mode may include mode 1 and mode 2 and the second processing mode may include mode 3 and mode 4; the processing the element 1 and the element 2 in the first processing mode may include: processing the element 1 in the mode 1 of the first processing mode and processing the element 2 in the mode 2 of the first processing mode, i.e., the element 1 and the element 2 are treated by different processing modes. The processing the element 3 in the second processing mode may include: processing the element 3 in the mode 3 of the second processing mode, or processing the element 3 in the mode 4 of the second processing mode.

In one embodiment of the present disclosure, the feature data of the UI object satisfying a preset condition corresponding to the element may include: a type of the UI object belonging to a preset type.

In one embodiment of the present disclosure, in the case that a type of the UI object does not belong to a preset type, the feature data of the UI object satisfying a preset condition corresponding to the element includes satisfying at least one of: condition a: a position of the UI object being located within a field of view; condition b: a ratio of an area of non-occluded part of the UI object to a total area of the UI objects being greater than a second preset ratio; condition c: a ranking of a ratio of an area of non-occluded part of the UI object to a total area of the UI object being lower than a third preset ranking in a ratio order; wherein the ratio order is obtained by sorting ratios of areas of non-occluded parts respectively corresponding to the plurality of UI objects to a corresponding total area in a descending order; condition d: a ranking of a focus time corresponding to the UI object being lower than a fourth preset ranking in a focus order; wherein the focus order is obtained by sorting focus times respectively corresponding to the plurality of UI objects in a chronological order; the focus time corresponds to a time when a UI object is recorded as a focus UI after completing an interactive event injection; condition e: the element being used.

The detailed description may refer to the above conditions 1-5 and will not be repeated here.

FIG. 6 illustrates a schematic flowchart IV of the method for image rendering provided by an embodiment of the present disclosure. In this embodiment, the UI object includes a plurality of elements, e.g., first element and second element. The approach of adopting different dynamic screen strategies for various elements in the UI object is exemplarily described. The method for image rendering includes:
601: obtaining a plurality of UI objects to be rendered.
602: for each of the plurality of UI objects, determining whether the feature data of the UI object satisfy the first preset condition; if yes, executing step 603; if not, executing step 604.
603: rendering and displaying a first element of the UI object in a first definition.
604: rendering and displaying a first element of the UI object in a second definition; the first definition being greater than the second definition.
605: determining whether the feature data of the UI object satisfy the second preset condition; if yes, executing step 606; if not, executing step 607.
606: rendering and displaying a second element of the UI object in a first definition.
607: rendering and displaying a second element of the UI object in a second definition.

Specifically, the UI object may include a plurality of elements. As an example, the UI object may be an application window, including application display contents and an operation control below the display contents (which may be a combination of horizontal stripes or dots). The same UI object may have different importance, so various dynamic screen strategies may be applied to different elements of the UI object. As a result, the elements of less importance are rendered and displayed in low definition, to avoid occupying too many resources of the graphics card and release more rendering pressure on the GPU.

In one embodiment of the present disclosure, the feature data of the UI object satisfying a second preset condition may include: a type of the UI object belonging to a preset type.

In one embodiment, in the case that a type of the UI object does not belong to a preset type, the feature data of the UI object satisfying a second preset condition includes satisfying at least one of: condition 6: a position of a first element of the UI object being located within a field of view; condition 7: a ratio of an area of non-occluded part of a first element of the UI object to a total area of the UI objects being greater than a second preset ratio; condition 8: a ranking of a ratio of an area of non-occluded part of a first element of the UI object to a total area of the UI object being lower than a third preset ranking in a ratio order; wherein the ratio order is obtained by sorting ratios of areas of non-occluded parts respectively corresponding to the plurality of UI objects to a corresponding total area in a descending order; condition 9: a ranking of a focus time corresponding to the UI object being lower than a fourth preset ranking in a focus order; wherein the focus order is obtained by sorting focus times respectively corresponding to the plurality of UI objects in a chronological order; the focus time corresponds to a time when a UI object is recorded as a focus UI after completing an interactive event injection; condition 10: a second element of the UI object being used.

Specifically, where the preset type is used as a high priority condition, the UI objects failing to meet the preset type may be further determined based on the conditions 6-10. Specifically, one or more conditions may be selected from the conditions 6-10 and further combined to obtain the first preset condition. As an example, the condition 6 may serve as the first preset condition; the conditions 6 and 7 may collectively serve as the first preset condition; the conditions 6-8 may collectively serve as the first preset condition; the conditions 6-10 may collectively serve as the first preset condition; the conditions 6, 7 and 9 may collectively serve as the first preset condition; the conditions 6, 8 and 9 may collectively serve as the first preset condition; the conditions 7 and 9 may collectively serve as the first preset condition.

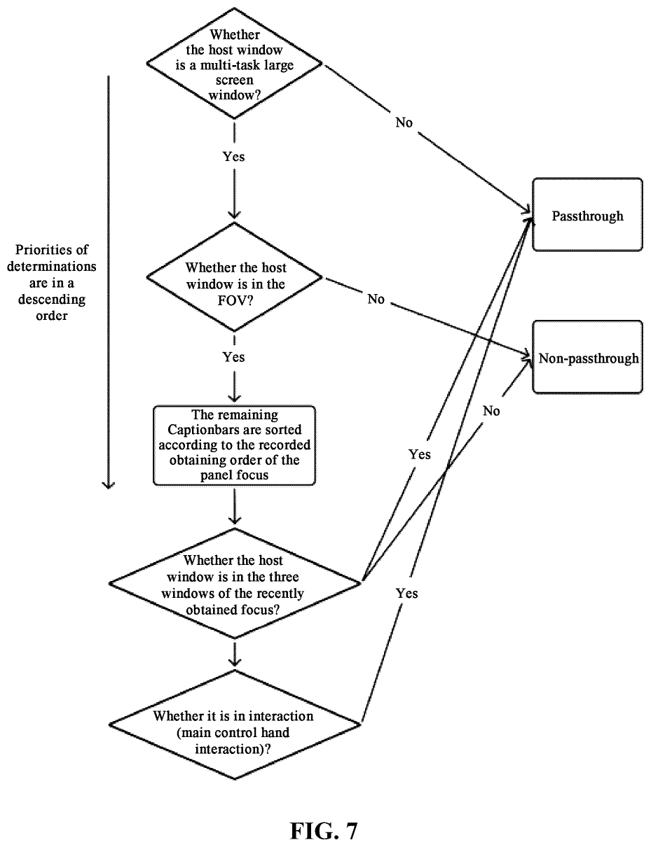

As an example, a host window is the UI object in FIG. 7. In the determination, first it is determined whether the type of the UI object is a preset type (i.e., non-third party nonresident application UI); if the type of the UI is the preset type, it means that it is not a multi-task large screen window; accordingly, the UI object is passed through, rendered and displayed in a high definition (first definition). If it is a multi-task large screen window, a further judgment is made. In the further judgment, it is determined whether the window of the UI object is in the field of view. If not, the non-passthrough is performed and the UI object is rendered and displayed in a low definition (second definition). If yes, a sorting is made according to the obtaining time of the focus. The first n (e.g., n being 3) UI objects are selected and passed through, while the rest is performed in the non-passthrough mode. It is further determined whether the UI object is in interactions, e.g., click and drag etc.; if yes, the passthrough is performed.

It is known from the above description that different elements of the UI object are dynamically selected according to various strategies and the screened elements are rendered and displayed in high definition. Such approach can adapt to the situation where different elements of the UI object are of various importance, and the important elements of the UI object are rendered and displayed in a high definition as much as possible while the less important elements of the UI object are rendered and displayed in a low definition. Therefore, a balance between the device performance and the visual experience of the user is achieved. Meanwhile, the battery life is extended as long as possible.

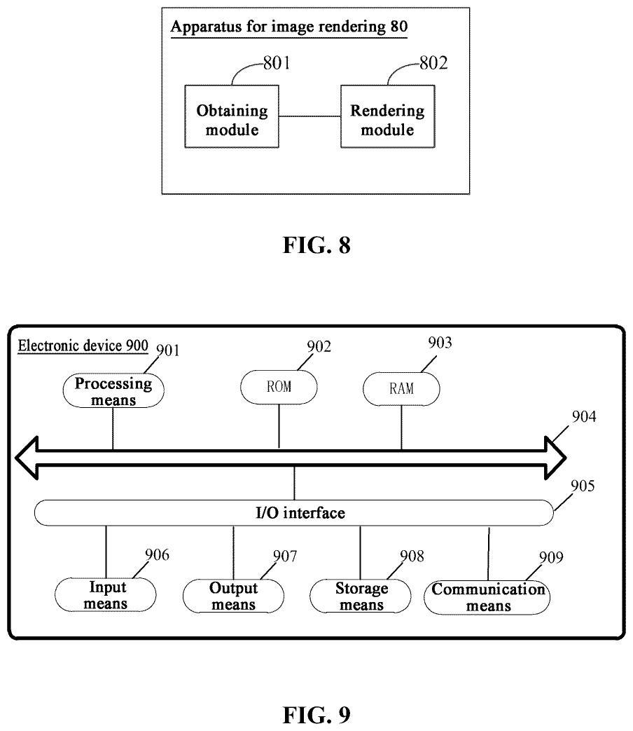

Corresponding to the above method for image rendering, FIG. 8 illustrates a structural diagram of a device for image rendering provided by an embodiment of the present disclosure. To facilitate the description, only the elements related to the embodiments of the present disclosure are shown. With reference to FIG. 8, the device includes: an obtaining module 801 and a rendering module 802.

Wherein an obtaining module 801 is configured to obtain a plurality of graphical user interface UI objects to be rendered;

A rendering module 802 is configured to, for each of the plurality of UI objects, if feature data of the UI object satisfy a first preset condition, render and display the UI object based on a first processing mode; and if the feature data of the UI object fail to satisfy the first preset condition, render and display the UI object based on a second processing mode; wherein a resource consumption of the first processing mode is greater than a resource consumption of the second processing mode.

In one embodiment of the present disclosure, the rendering module 802 is specifically configured to: render and display the UI object in a first definition; render and display the UI object in a second definition, wherein the first definition is greater than the second definition.

In one embodiment of the present disclosure, the rendering module 802 is specifically configured to: refresh a window of the UI object at a first refresh rate; refresh a window of the UI object at a second refresh rate; wherein the first refresh rate is greater than the second refresh rate.

In one embodiment of the present disclosure, the rendering module 802 is specifically configured to: render a window of the UI objects with a first resolution; render a window of the UI objects with a second resolution; wherein the first resolution is greater than the second resolution.

In one embodiment of the present disclosure, the rendering module 802 is specifically configured to: in case of rendering and displaying the UI object based on a second processing mode, freeze a process corresponding to the UI object and display, in a window of the UI object, a first image which is rendered and displayed before freezing of process; or, ending a process corresponding to the UI object and displaying, in a window of the UI object, a second image which is rendered and displayed before freezing of process.

In one embodiment of the present disclosure, feature data of the UI object include at least one of: a type, a position, an area of a non-occluded part, or interactive data.

In one embodiment of the present disclosure, the feature data of the UI object satisfying a first condition includes: feature data of the UI object belonging to a preset type.

In one embodiment of the present disclosure, the preset type includes a safety type.

In one embodiment of the present disclosure, the preset type includes a customized type; and the obtaining module 801 is further configured to: in response to an operation of triggering a first control in the setting interface, determine the type of the selected UI object as the customized type.

In one embodiment of the present disclosure, in the case that a type of the UI object does not belong to a preset type, the feature data of the UI object satisfying a first condition includes satisfying at least one of:
a position of the UI object being located within a field of view;
a ratio of an area of non-occluded part of the UI object to a total area of the UI objects being greater than a first preset ratio;
a ranking of a ratio of an area of non-occluded part of the UI object to a total area of the UI object being lower than a first preset ranking in a ratio order; wherein the ratio order is obtained by sorting ratios of areas of non-occluded parts respectively corresponding to the plurality of UI objects to a corresponding total area in a descending order;
a ranking of a focus time corresponding to the UI object being lower than a second preset ranking in a focus order; wherein the focus order is obtained by sorting focus times respectively corresponding to the plurality of UI objects in a chronological order; the focus time corresponds to a time when a UI object is recorded as a focus UI after completing an interactive event injection.

In one embodiment of the present disclosure, in the case that a type of the UI object does not belong to a preset type, the feature data of the UI object satisfying a first preset condition includes:
a position of the UI object being located in a field of view and a ranking of a focus time corresponding to the UI object being lower than a second preset ranking in a focus order;
Or,
a position of the UI object being located in a field of view, a ranking of a focus time corresponding to the UI object being lower than a second preset ranking in a focus order, and a ranking of a ratio of an area of non-occluded part of the UI object to a total area of the UI object being lower than a first preset ranking in a ratio order.

In one embodiment of the present disclosure, the obtaining module 801 is further configured to: obtain a current pose of a headset device; determine a field of view of a headset device according to the current pose.

In one embodiment of the present disclosure, the obtaining module 801 is further configured to: obtain a current eye movement tracking result; determine a field of view of a headset device based on the current pose and the eye movement tracking result.

In one embodiment of the present disclosure, the UI object includes a plurality of elements; the plurality of elements correspond respectively to their own preset conditions; the rendering module 802 is specifically configured to: for each element of the UI object, if feature data of the UI object satisfy a preset condition corresponding to the element, render and display the element in a first processing mode; if feature data of the UI object fail to satisfy a preset condition corresponding to the element, render and display the element in a second processing mode.

In one embodiment of the present disclosure, the feature data of the UI object satisfying a preset condition corresponding to the element includes: a type of the UI object belonging to a preset type.

In one embodiment of the present disclosure, in the case that a type of the UI object does not belong to a preset type, the feature data of the UI object satisfying a preset condition corresponding to the element includes satisfying at least one of:
a position of the UI object being located within a field of view;
a ratio of an area of non-occluded part of the UI object to a total area of the UI objects being greater than a second preset ratio;
a ranking of a ratio of an area of non-occluded part of the UI object to a total area of the UI object being lower than a third preset ranking in a ratio order; wherein the ratio order is obtained by sorting ratios of areas of non-occluded parts respectively corresponding to the plurality of UI objects to a corresponding total area in a descending order;
a ranking of a focus time corresponding to the UI object being lower than a fourth preset ranking in a focus order; wherein the focus order is obtained by sorting focus times respectively corresponding to the plurality of UI objects in a chronological order; the focus time corresponds to a time when a UI object is recorded as a focus UI after completing an interactive event injection;
the element being used.

In one embodiment of the present disclosure, the rendering module 802 is specifically configured to: based on the Compositor Layer technique, submit a scene content corresponding to the UI object directly to an asynchronous timewarp ATW thread for processing without being rendered by a rendering thread, to further render and display in a first definition on a screen of a headset device; submit a scene content corresponding to the UI object to a rendering thread for rendering of left-eye and right-eye cameras and submit data rendered in left-eye and right-eye rendering buffers to an asynchronous timewarp ATW thread for processing, to render and display in a second definition on a screen of a headset device.

In one embodiment of the present disclosure, the obtaining module 801 is further configured to: in response to an operation of triggering a second control in the setting interface, determine a target visual experience level, wherein different visual experience levels correspond to various strict degrees of the preset conditions for rendering and displaying the UI object; and determine a preset condition corresponding to the target level as the first preset condition.

The device provided by this embodiment may be used to execute the technical solution of the above method embodiments. The implementation principles and the technical effects are similar and will not be repeated here.

To implement the above embodiments, embodiments of the present disclosure also provide an electronic device.

FIG. 9 illustrates a structural diagram of an electronic device 900 adapted to implement embodiments of the present disclosure. The electronic device 900 may be a terminal device or a server, wherein the terminal device may include, but not limited to, mobile terminals, such as mobile phones, notebooks, digital broadcast receivers, PDA (Personal Digital Assistant), PAD (Portable Android Device), PMP (Portable Multimedia Player) and vehicle terminals (such as car navigation terminal) and fixed terminals, e.g., digital TVs and desktop computers etc. The electronic device shown in FIG. 9 is just an example and will not put any restrictions on the functions and application ranges of the embodiments of the present disclosure.

According to FIG. 9, the electronic device 900 may include a processing means (e.g., central processor, graphic processor and the like) 901, which can execute various suitable actions and processing based on the programs stored in the read-only memory (ROM) 902 or programs loaded in the random-access memory (RAM) 903 from a storage means 908. The RAM 903 can also store all kinds of programs and data required by the operations of the electronic device 900. Processing means 901, ROM 902 and RAM 903 are connected to each other via a bus 904. The input/output (I/O) interface 905 is also connected to the bus 904.

Usually, input means 906 (including touch screen, touchpad, keyboard, mouse, camera, microphone, accelerometer, gyroscope and like) and output means 907 (including liquid crystal display (LCD), speaker and vibrator etc.), storage means 908 (including tape and hard disk etc.) and communication means 909 may be connected to the I/O interface 905. The communication means 909 may allow the electronic device 900 to exchange data with other devices through wired or wireless communications. Although FIG. 9 illustrates the electronic device 900 having various means, it is to be understood that it is not a prerequisite to implement or provide all illustrated means. Alternatively, more or less means may be implemented or provided.

In particular, in accordance with embodiments of the present disclosure, the process depicted above with reference to the flowchart may be implemented as computer software programs. For example, the embodiments of the present disclosure include a computer program product including a computer program carried on a computer readable medium, wherein the computer program include program codes for executing the method demonstrated by the flowchart. In these embodiments, the computer program may be loaded and installed from networks via the communication means 909, or installed from the storage means 908, or installed from the ROM 902. The computer program, when executed by the processing means 901, performs the above functions defined in the method according to the embodiments of the present disclosure.

It is to be explained the above disclosed computer readable medium may be computer readable signal medium or computer readable storage medium or any combinations thereof. The computer readable storage medium for example may include, but not limited to, electric, magnetic, optical, electromagnetic, infrared or semiconductor systems, apparatus or devices or any combinations thereof. Specific examples of the computer readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof. In the present disclosure, the computer readable storage medium may be any tangible medium that contains or stores programs. The programs may be utilized by instruction execution systems, apparatuses or devices in combination with the same. In the present disclosure, the computer readable signal medium may include a data signal propagated in baseband or as part of a carrier wave, carrying computer readable program codes therein. Such propagated data signals may take many forms, including but not limited to, electromagnetic signals, optical signals, or any suitable combinations thereof. The computer readable signal medium may also be any computer readable medium in addition to the computer readable storage medium. The computer readable signal medium may send, propagate, or transmit programs for use by or in connection with instruction execution systems, apparatuses or devices. Program codes contained on the computer readable medium may be transmitted by any suitable media, including but not limited to: electric wires, fiber optic cables and RF (radio frequency) etc., or any suitable combinations thereof.

The above computer readable medium may be included in the aforementioned electronic device or stand-alone without fitting into the electronic device.

The above computer readable medium bears one or more programs. When the above one or more programs are executed by the electronic device, the electronic device is enabled to execute the method illustrated by the above embodiments.

Computer program instructions for executing operations of the present disclosure are written in one or more programming languages or combinations thereof. The above programming languages include object-oriented programming languages, e.g., Java, Smalltalk, C++ and so on, and traditional procedural programming languages, such as “C” language or similar programming languages. The program codes can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider).

The flow chart and block diagram in the drawings illustrate system architecture, functions and operations that may be implemented by a system, method and computer program product according to various implementations of the present disclosure. In this regard, each block in the flow chart or block diagram can represent a module, an element of program segment or code, wherein the module and the element of program segment or code include one or more executable instruction for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Units described in the embodiments of the present disclosure may be implemented by software or hardware. In some cases, the name of the unit should not be considered as the restriction over the unit per se. For example, the first obtaining unit also may be described as “a unit for obtaining at least two Internet protocol addresses”.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

In the context of the present disclosure, machine readable medium may be tangible medium that may include or store programs for use by or in connection with instruction execution systems, apparatuses or devices. The machine readable medium may be machine readable signal medium or machine readable storage medium. The machine readable storage medium for example may include, but not limited to, electric, magnetic, optical, electromagnetic, infrared or semiconductor systems, apparatus or devices or any combinations thereof. Specific examples of the machine readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof.

The above description only explains the preferred embodiments of the present disclosure and the technical principles applied. Those skilled in the art should understand that the scope of the present disclosure is not limited to the technical solution resulted from particular combinations of the above technical features, and meanwhile should also encompass other technical solutions formed from any combinations of the above technical features or equivalent features without deviating from the above disclosed inventive concept, such as the technical solutions formed by substituting the above features with the technical features disclosed here with similar functions.

Furthermore, although the respective operations are depicted in a particular order, it should be appreciated that the operations are not required to be completed in the particular order or in succession. In some cases, multitasking or multiprocessing is also beneficial. Likewise, although the above discussion includes some particular implementation details, they should not be interpreted as limitations over the scope of the present disclosure. Some features described separately in the context of the embodiments of the description can also be integrated and implemented in a single embodiment. Conversely, all kinds of features described in the context of a single embodiment can also be separately implemented in multiple embodiments or any suitable sub-combinations.

Although the subject matter is already described by languages specific to structural features and/or method logic acts, it is to be appreciated that the subject matter defined in the attached claims is not limited to the above described particular features or acts. On the contrary, the above described particular features and acts are only example forms for implementing the claims.

I/We claim:

1. A method for image rendering, wherein the method is applied to a headset device and comprises:
obtaining a plurality of graphical user interface (UI) objects to be rendered; and
for each of the plurality of UI objects, in response to feature data of the UI object satisfying a first preset condition, rendering and displaying the UI object based on a first processing mode; and in response to the feature data of the UI object failing to satisfy the first preset condition, rendering and displaying the UI object based on a second processing mode; wherein a resource consumption of the first processing mode is greater than a resource consumption of the second processing mode.

2. The method of claim 1, wherein rendering and displaying the UI object based on the first processing mode comprises:
rendering and displaying the UI object in a first definition;
wherein rendering and displaying the UI object based on the second processing mode comprises:
rendering and displaying the UI object in a second definition, wherein the first definition is greater than the second definition.

3. The method of claim 1, wherein rendering and displaying the UI object based on the first processing mode comprises:
refreshing a window of the UI object at a first refresh rate;
wherein rendering and displaying the UI object based on the second processing mode comprises:
refreshing the window of the UI object at a second refresh rate; wherein the first refresh rate is greater than the second refresh rate.

4. The method of claim 1, wherein rendering and displaying the UI object based on the first processing mode comprises:
rendering a window of the UI objects with a first resolution;
wherein rendering and displaying the UI object based on the second processing mode comprises:
rendering the window of the UI objects with a second resolution; wherein the first resolution is greater than the second resolution.

5. The method of claim 1, wherein rendering and displaying the UI object based on the second processing mode comprises at least one of:
freezing a process corresponding to the UI object and displaying, in a window of the UI object, a first image which is rendered and displayed before freezing the process; and
ending the process corresponding to the UI object and displaying, in the window of the UI object, a second image which is rendered and displayed before freezing the process.

6. The method of claim 1, wherein the feature data of the UI object comprise at least one of: a type, a position, an area of non-occluded part, or interactive data.

7. The method of claim 1, wherein the feature data of the UI object satisfying the first condition comprises:
the feature data of the UI object belonging to a preset type.

8. The method of claim 7, wherein the preset type comprises a safety type.

9. The method of claim 7, wherein in a case that a type of the UI object does not belong to the preset type, the feature data of the UI object satisfying the first condition comprises satisfying at least one of:
a position of the UI object being located within a field of view;
a ratio of an area of non-occluded part of the UI object to a total area of the UI objects being greater than a first preset ratio;
a ranking of a ratio of an area of non-occluded part of the UI object to a total area of the UI object being lower than a first preset ranking in a ratio order; wherein the ratio order is obtained by sorting ratios of areas of non-occluded parts respectively corresponding to the plurality of UI objects to a corresponding total area in a descending order;
a ranking of a focus time corresponding to the UI object being lower than a second preset ranking in a focus order; wherein the focus order is obtained by sorting focus times respectively corresponding to the plurality of UI objects in a chronological order; and wherein the focus time corresponds to a time when a UI object is recorded as a focus UI after completing an interactive event injection.

10. The method of claim 7, wherein in a case that a type of the UI object does not belong to the preset type, the feature data of the UI object satisfying the first preset condition comprises:
a position of the UI object being located in a field of view and a ranking of a focus time corresponding to the UI object being lower than a second preset ranking in a focus order; or
a position of the UI object being located in a field of view, a ranking of a focus time corresponding to the UI object being lower than a second preset ranking in a focus order, and a ranking of a ratio of an area of non-occluded part of the UI object to a total area of the UI object being lower than a first preset ranking in a ratio order.

11. The method of claim 9, wherein the method further comprises:
obtaining a current pose of the headset device; and
determining a field of view of the headset device according to the current pose.

12. The method of claim 11, wherein determining the field of view of the headset device according to the current pose comprises:
obtaining a current eye movement tracking result; and
determining the field of view of the headset device based on the current pose and the eye movement tracking result.

13. The method of claim 1, wherein the UI object comprises a plurality of elements; the plurality of elements correspond respectively to their own preset conditions; wherein in response to the feature data of the UI object satisfying the first preset condition, rendering and displaying the UI object based on the first processing mode; and in response to the feature data of the UI object failing to satisfy the first preset condition, rendering and displaying the UI object based on the second processing mode comprise:
for each element of the UI object, in response to the feature data of the UI object satisfying a preset condition corresponding to the element, rendering and displaying the element in the first processing mode; and in response to the feature data of the UI object failing to satisfy the preset condition corresponding to the element, rendering and displaying the element in the second processing mode.

14. The method of claim 13, wherein the feature data of the UI object satisfying the preset condition corresponding to the element comprises:
a type of the UI object belonging to a preset type.

15. The method of claim 14, wherein in a case that the type of the UI object does not belong to the preset type, the feature data of the UI object satisfying the preset condition corresponding to the element comprises satisfying at least one of:
a position of the UI object being located within a field of view;
a ratio of an area of non-occluded part of the UI object to a total area of the UI objects being greater than a second preset ratio;
a ranking of a ratio of an area of non-occluded part of the UI object to a total area of the UI object being lower than a third preset ranking in a ratio order; wherein the ratio order is obtained by sorting ratios of areas of non-occluded parts respectively corresponding to the plurality of UI objects to a corresponding total area in a descending order; or
a ranking of a focus time corresponding to the UI object being lower than a fourth preset ranking in a focus order; wherein the focus order is obtained by sorting focus times respectively corresponding to the plurality of UI objects in a chronological order; and wherein the focus time corresponds to a time when a UI object is recorded as a focus UI after completing an interactive event injection; or
the element being used.

16. The method of claim 1, wherein rendering and displaying the UI object based on the first processing mode comprises:
based on a Compositor Layers technique, submitting a scene content corresponding to the UI object directly to an asynchronous timewarp (ATW) thread for processing without being rendered by a rendering thread, to render and display in a first definition on a screen of the headset device;
wherein rendering and displaying the UI object based on the second processing mode comprises:
submitting the scene content corresponding to the UI object to the rendering thread for rendering of left-eye and right-eye cameras and submitting data rendered in left-eye and right-eye rendering buffers to the ATW thread for processing, to render and display in a second definition on the screen of the headset device.

17. An electronic device comprising a processor and a memory, wherein the memory stores computer-executable instructions, when executed by the processor, cause the processor to:
obtain a plurality of graphical user interface (UI) objects to be rendered; and
for each of the plurality of UI objects, in response to feature data of the UI object satisfying a first preset condition, render and display the UI object based on a first processing mode; and in response to the feature data of the UI object failing to satisfy the first preset condition, render and display the UI object based on a second processing mode; wherein a resource consumption of the first processing mode is greater than a resource consumption of the second processing mode.

18. The method of claim 17, wherein the computer-executable instructions that cause the processor to render and display the UI object based on the first processing mode comprise instructions to cause the processor to:
render and display the UI object in a first definition;
wherein the computer-executable instructions that cause the processor to render and display the UI object based on the second processing mode comprise instructions to cause the processor to:
render and display the UI object in a second definition, wherein the first definition is greater than the second definition.

19. the electronic device of claim 17, wherein the UI object comprises a plurality of elements; the plurality of elements correspond respectively to their own preset conditions; wherein the computer-executable instructions that cause the processor to, in response to the feature data of the UI object satisfying the first preset condition, render and display the UI object based on the first processing mode; and in response to the feature data of the UI object failing to satisfy the first preset condition, render and display the UI object based on the second processing mode comprise instructions to cause the processor to:
for each element of the UI object, in response to the feature data of the UI object satisfying a preset condition corresponding to the element, render and display the element in the first processing mode; and in response to the feature data of the UI object failing to satisfy the preset condition corresponding to the element, render and display the element in the second processing mode.

20. A non-transitory computer-readable storage medium having computer-executable instructions stored therein, wherein the computer-executable instructions, when executed by a processor, cause the processor to:
obtain a plurality of graphical user interface (UI) objects to be rendered; and
for each of the plurality of UI objects, in response to feature data of the UI object satisfying a first preset condition, render and display the UI object based on a first processing mode; in response to the feature data of the UI object failing to satisfy the first preset condition, render and display the UI object based on a second processing mode; wherein a resource consumption of the first processing mode is greater than a resource consumption of the second processing mode.
